(19) United States
(12) Patent Application Publication
(10) Pub. No.: US 2010/0027256 A1
(43) Pub. Date: Feb. 4, 2010

(54) OPTICAL ELEMENT FOR ARRAYED LIGHT SOURCE AND LIGHT EMITTING DEVICE USING THE SAME

(75) Inventor: Junichi KINOSHITA, Imabari-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: HARISON TOSHIBA LIGHTING Corp., Imabari-shi (JP)

(21) Appl. No.: 12/512,496

(22) Filed: Jul. 30, 2009

(30) Foreign Application Priority Data
Aug. 4, 2008 (JP) 2008-201037

(51) Int. Cl. F21V 1/00

(52) U.S. Cl. 362/235

(57) ABSTRACT

An optical element for arrayed light source has a bar-like optical element and a light guide portion, which is a bar-like part formed on an incident portion side of the optical element portion, has a totally reflecting portion which causes emitted light from each of a plurality of LED that has an angle not less than a prescribed angle relative to an optical axis plane of the optical element portion to be totally reflected toward a plurality of concavo-convex reflecting portions provided between two LEDs adjacent to each other, the plurality of LEDs being arranged in a linear manner or an annular manner. The light guide portion guides, to the incident portion of the optical element portion, light reflected in each of the plurality of concavo-convex reflecting portions and emitted light that has an angle less than the prescribed angle.

### CROSS-REFERENCE TO RELATED APPLICATION

This application is based upon and claims the benefit of priority from the prior Japanese Patent Application No. 2008-201037 filed in Japan on Aug. 4, 2008, the entire contents of which are incorporated herein by this reference.

### BACKGROUND OF THE INVENTION

1. Field of the Invention

The present invention relates to an optical element for arrayed light source and a light emitting device in which the optical element for arrayed light source is used.

2. Description of Related Art

A planar luminaire which causes plane light emission to occur on a luminous surface by using emitted light from solid light emitting elements, such as an LED (light emitting diode) and an LD (laser diode), which are point sources of light, has hitherto been widely used in a backlight device and the like.

The light guide plate method which involves causing light to be incident on a light guide plate sideways or the direct method which involves diffusing light by using a diffuser installed above a plurality of LEDs arranged in a one-dimensionally arrayed manner (i.e., linearly) or a two-dimensionally arrayed manner (i.e., in a matrix) has been mainstream in methods of converting light from a plurality of light emitting elements to light over a planar luminous surface.

The conventional light guide type luminaire and the conventional direct type luminaire have defects as described below. In the light guide plate method, a light guide plate which is thin and light in weight can be used when the luminous surface is small. However, the light guide plate method poses a problem that the light guide plate becomes heavy when the area of a luminous surface becomes wide. In the direct method, in which luminous spots of the array of point sources of light are made uniform by being diffused, it is necessary to ensure a long distance to the diffuser and hence this method has a disadvantage that the whole device becomes thick.

Therefore, as the third method which is intended for overcoming these disadvantages, the hollow cavity method has been proposed (refer to, for example, Japanese Patent Application Laid-Open Publication No. 2006-106212 and “RGB-LED Backlighting Monitor/TV for Reproduction of Images in Standard and Extended Color Spaces” written by K. Kalantar and M. Okada, IDW 04 Digest, pp. 683-686 (2004)). FIG. 12 is a sectional view showing an example of configuration of a conventional hollow cavity type planar luminaire.

A hollow cavity type planar luminaire of FIG. 12 has a simple hollow cavity structure in which the planar luminaire is provided, on a bottom surface thereof, with reflectors 111, 112, and is provided, on a top surface thereof, with a diffuser 103, and a light source 101 of a plurality of LEDs is linearly arranged on a side surface thereof. The hollow cavity type planar luminaire has an advantage that weight saving is possible because of the absence of a light guide plate although light is radiated from the side where the LED light source 101 is present. Furthermore, light is radiated to the reflectors 111, 112 and the diffuser 103 at relatively shallow angles and, therefore, it is unnecessary to increase the distance from the bottom surface to the diffuser 103, i.e., the thickness of the device, unlike the direct method, in order to eliminate luminous spots.

However, the reflector 111 is inclined so as to bend downward from one end of the light source 101 side toward the bottom surface and the reflector 112 is inclined as to bend upward from the other end of the reflector 111 toward the top surface. In the hollow cavity type planar luminaire of FIG. 12, there is a reflector 113 also on the top surface side in the vicinity of the light source 101 and hence this planar luminaire has a problem that it is impossible to make the hollow cavity portion thinner.

In this hollow cavity type planar luminaire, techniques have been proposed for realizing a thin hollow cavity structure with enhanced uniformity (refer to Japanese Patent Application Laid-Open Publication No. 2008-60061, for example). FIG. 13 is a sectional view showing an example of configuration of this thin hollow cavity type planar luminaire. According to this proposal, as shown in FIG. 13, an optical element for LED-array light source is arranged for each of emission portions of two LED arrays arranged on two opposed side face parts. This is because the luminous intensity distribution from the LED arrays, which is very similar to the Lambert distribution, cannot be used as it is in the hollow cavity reflection method. As shown in FIG. 13, an LED substrate 122 on which a plurality of LEDs 121 are arranged in a linear manner is provided on a side face part of a unit case. An optical element for LED-array light source 123 is provided on the emitted light side of each of the LEDs 121, and a reflecting surface member 124 is provided in the middle part of the unit case.

FIG. 14 is a diagram to explain the LED substrate and the optical element for LED-array light source in FIG. 13. As shown in FIG. 14, the optical element for LED-array light source 123 is configured in such a manner that the light from each of the LEDs 121 is totally reflected on the whole reflecting surface and is refracted on a surface of emission so that the luminous intensity distribution in a direction orthogonal to the front surface of a luminous surface member 125 becomes small. The plurality of LEDs 121 of the LED substrate 122 are arranged so as to be positioned in a concavity of the optical element for LED-array light source 123. The light from each of the LEDs 121 is converted in such a manner that the luminous intensity distribution becomes an optimum distribution by narrowing the luminous intensity distribution in the vertical direction, i.e., in the thickness direction of the hollow-cavity light guide region so that uniform plane light emission is obtained in a luminaire of a hollow cavity type reflecting structure by using this optical element for LED-array light source 123.

FIG. 15 is a sectional view of the optical element for LED-array light source in FIG. 13. As shown in FIG. 15, the optical element for LED-array light source 123 is such that a convexity is formed in a light entrance portion 123a thereby to increase the coupling efficiency and first-stage collimation is performed in the light entrance portion 123a. Wide-angle components of the light which enters the light entrance portion 123a is collimated in a totally reflecting rim portion 123b of the outer hull, and narrow-angle paraxial components of the light are collimated in a convex lens portion 123c. And the optical element for LED-array light source 123 is of a simple structure having almost the same sectional shape in the array direction in which the plurality of LEDs 121 line up.

Unlike a circular optical element, a cylindrical lens system which is uniform in the array direction is used in the optical element of FIG. 15. Hence, in the case of the proposed luminaire described above, not only the ray components in the sectional direction shown in FIG. 15, but also ray components in the array direction are important. Wide-angle components in the array direction are only guided in the array direction and become stray light at the front, i.e., in the optical axis direction, which is difficult to convert to ray components. Hence, the conventional hollow cavity method has the problem that the efficiency of conversion of the light which spreads in the array direction to the optical axis direction in the collimator in the above-described proposal decreases by just the stray light.

Also, in order to cover wide-angle components, it is necessary to design the totally reflecting rim portion 123b so as to become large in the vertical direction, i.e., in the thickness direction of the hollow-cavity light guide region. In order to cover a low-power part in the skirt part of the Lambert distribution of the LED 121, a large width, i.e., a longitudinal length in FIG. 15 becomes necessary. Hence, the conventional hollow cavity method has also a problem that the ratio of the area occupied by the optical element for LED-array light source 123 in the thickness direction of the luminaire is not low and that the efficiency of the device with respect to space is low.

Furthermore, there are also many wide-angle components which return to the LED 121 side due to internal reflection because the array direction of the light entrance portion 123a is uniform, thereby posing a problem.

### BRIEF SUMMARY OF THE INVENTION

According to an aspect of the present invention, it is possible to provide an optical element for arrayed light source, which includes a bar-like or annular optical element portion and a light guide portion. The light guide portion has a bar-like or annular shape provided on an incident portion side of the optical element portion, and has a totally reflecting portion which causes emitted light from each of a plurality of light emitting elements that has an angle not less than a prescribed angle relative to an optical axis plane of the optical element portion to be totally reflected toward a plurality of concavo-convex reflecting portions provided between two light emitting elements adjacent to each other, the plurality of light emitting elements being arranged in a linear manner or an annular manner and each having directionality. The light guide portion guides, to the incident portion of the optical element portion, light reflected in each of the plurality of concavo-convex reflecting portions and emitted light from each of the plurality of light emitting elements that has an angle less than the prescribed angle.

According to another aspect of the present invention, it is possible to provide a light emitting device that is a light emitting device having a luminous surface and includes a light source having an optical element for arrayed light source of the present invention, a diffuser arranged so as to be spaced a prescribed distance from an optical axis plane of emitted light from the light source, and a reflecting member which has an inclined surface having a prescribed inclination with respect to the optical axis plane so that illuminance distribution on the luminous surface becomes uniform, forms a hollow cavity region with the diffuser, and emits reflected light from the inclined surface to the diffuser via the hollow cavity region.

### BRIEF DESCRIPTION OF THE DRAWINGS

FIG. 1 is a sectional view of a light emitting device according to an embodiment of the present invention;

FIG. 2 is a perspective view to explain an example of configuration of a light source according to the embodiment of the present invention;

FIG. 3 is a sectional view of a light source including a collimator lens having a collimator lens portion and a light guide portion according to the embodiment of the present invention;

FIG. 4 is a perspective view of the collimator lens as viewed from the side where concavo-convex reflecting portions of the light guide portion are present according to the embodiment of the present invention;

FIG. 5 is a front view of the collimator lens as viewed from the side where concavo-convex reflecting portions of the light guide portion are present according to the embodiment of the present invention;

FIG. 6 is a sectional view as viewed from the direction of the arrows along the VI-VI line of FIG. 3;

FIG. 7 is a front view of a collimator lens as viewed from the side where concavo-convex reflecting portions of a light guide portion are present according to a first modification of the embodiment of the present invention;

FIG. 8 is a sectional view along the direction of the straight line L1 on which a plurality of concavo-convex reflecting portions of the light guide portion line up according to the first modification of the embodiment of the present invention;

FIG. 9 is a sectional view of the collimator lens along the IX-IX line in FIG. 8;

FIG. 10 is an assembly perspective view to explain the configuration of a light emitting device according to a second modification of the embodiment of the present invention;

FIG. 11A is a diagram to explain a modification of a light source according to a third modification of the embodiment of the present invention;

FIG. 11B is a diagram to explain a modification of a light source according to the third modification of the embodiment of the present invention;

FIG. 12 is a sectional view showing an example of configuration of a conventional hollow cavity type planar luminaire;

FIG. 13 is a sectional view showing an example of configuration of a conventional thin hollow cavity type planar luminaire;

FIG. 14 is a diagram to explain an LED substrate and an optical element for LED-array light source in FIG. 13; and

FIG. 15 is a sectional view of the optical element for LED-array light source in FIG. 13.

### DETAILED DESCRIPTION OF THE INVENTION

Hereinafter, an embodiment of the present invention will be described with reference to the drawings.

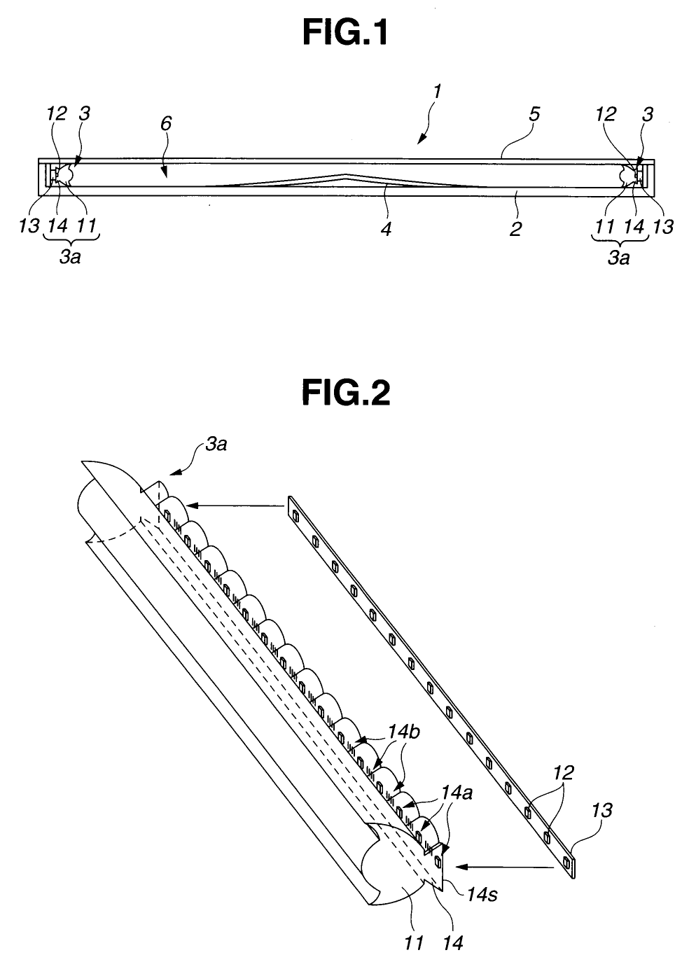

First, a description will be given of a light emitting device as a hollow-cavity type planar luminaire of the present embodiment. FIG. 1 is a sectional view of a light emitting device of the present embodiment.

As shown in FIG. 1, a box-shaped light emitting device 1 whose luminous surface has a rectangular shape, has two light sources 3 as two light emitting portions arranged on two side face parts of a box-shaped case 2, a reflecting member 4 having a reflecting surface provided in a bottom face portion inside the case 2, and a diffuser 5 as a luminous surface member which receives reflected light from the reflecting member 4 and emits the light to outside the light emitting device 1. A hollow cavity region 6 is formed between the reflecting member 4 and the diffuser 5. The reflecting member 4 has two prescribed inclined portions each of which bends downward from a ridge line of a peak part in the middle toward the two light sources 3, and a flat surface provided in the vicinity of an optical element for arrayed light source 3a. The reflecting member 4 reflects light from the side face parts and emits the light to the diffuser 5. As a result of this, the light emitting device 1 can emit light with a uniform illuminance distribution from the luminous surface of the diffuser 5. The light emitting device 1 is a hollow-cavity type light emitting device capable of obtaining plane light emission from the diffuser 5.

Each of the two light sources 3 includes a bar-like optical element for arrayed light source 3a and a substrate 13 on which a plurality of LEDs 12 are arranged in a linear manner. The two light sources 3 including the plurality of LEDs 12 which line up in a linear manner are used as side-illuminating light. Each of the LEDs 12 has luminous intensity distribution characteristics with directionality.

The optical element for arrayed light source 3a has an optical element portion 11 of a shape having a convex lens portion and a rim portion, which will be described later, and a light guide portion 14 provided on the incident portion side of the optical element portion 11. And the optical element portion 11 and the light guide portion 14 are integrally formed.

Incidentally, although in the present embodiment the optical element for arrayed light source 3a is such that the optical element portion 11 and the light guide portion 14 are integrally formed, the two optical members which are the optical element portion 11 and the light guide portion 14 may be bonded together as one optical element for arrayed light source.

In the present embodiment, the optical element for arrayed light source 3a is a collimator lens arranged on the emission portion side of the plurality of LEDs 12. This is because the luminous intensity distribution from the plurality of LEDs 12, which is very similar to the Lambert distribution, cannot be used as it is in the hollow cavity reflection method. As will be described later, the light guide portion 14 is formed on the incident portion side of the optical element portion 11 and has a bar-like shape which converts the luminous intensity distribution and the like of emitted light from the light emitting element.

As shown in FIG. 1, on the two side face parts of the box-shaped unit case 2, the LED substrates 13 on each of which the plurality of LEDs 12 are provided in an arrayed manner are arranged. The optical element for arrayed light source 3a is provided on the emitted light side of each of the LEDs 12, and the reflecting member 4 is provided in the middle part of the unit case.

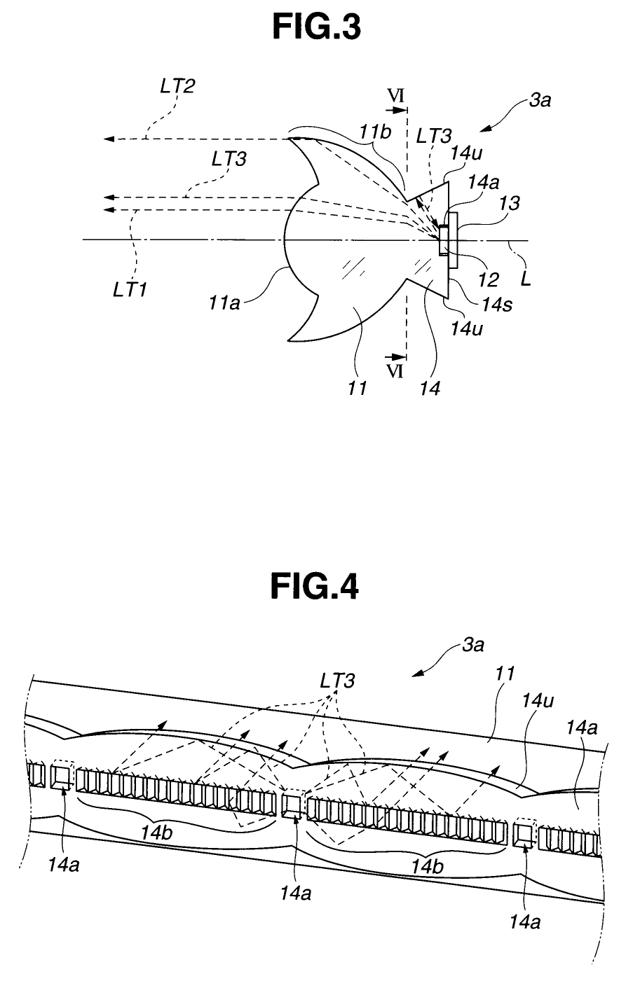

As shown in FIG. 3, the optical element portion 11 is a collimator lens part configured to cause the light from each of the LEDs 12 to be totally reflected on a totally reflecting surface and to be refracted on the surface of emission so that the luminous intensity distribution in a direction orthogonal to the surface of the diffuser 5 becomes small. The optical element portion 11 is an optical element which collects the light from each of the LEDs 12 so as to output the light in a direction parallel to the luminous surface of the diffuser 5, and is arranged parallel to the plurality of LEDs 12 on the emission portion side of the plurality of LEDs 12 arranged in a linear manner.

The light guide portion 14 is positioned between the incident light side of the optical element portion 11 and the emitted light side of the plurality of LEDs 12 of the substrate 13. The light from each of the LEDs 12 is converted in such a manner that the luminous intensity distribution becomes an optimum distribution by narrowing the luminous intensity distribution in the vertical direction, i.e., in the thickness direction of the hollow-cavity light guide region so that uniform plane emission is obtained in a luminaire of a hollow cavity type reflecting structure by using this optical element for LED-array light source 3a.

Next, the configuration of the optical element portion 11 and the light guide portion 14 will be described in more detail.

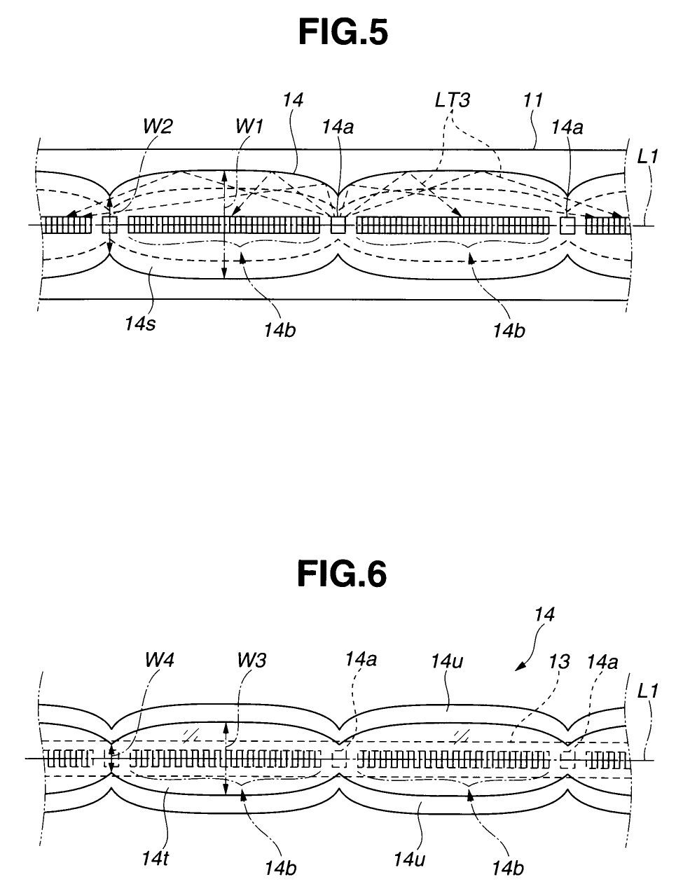

FIG. 2 is a perspective view to explain an example of configuration of the light source 3 of FIG. 1. FIG. 3 is a sectional view of the light source 3 including the optical element for arrayed light source 3a having the optical element portion 11 and the light guide portion 14. FIG. 4 is a perspective view of the optical element for arrayed light source 3a as viewed from the side where concavo-convex reflecting portions 14b of the light guide portion 14 are present. FIG. 5 is a front view of the optical element for arrayed light source 3a as viewed from the side where concavo-convex reflecting portions 14b of the light guide portion 14 are present. FIG. 6 is a sectional view as viewed from the direction of the arrows along the VI-VI line of FIG. 3.

As shown in FIG. 2, on the plate-like substrate 13 the plurality of LEDs 12 are provided in a linear manner at predetermined intervals from each other. The plurality of LEDs 12 line up in the order of, for example, from an end of the substrate 13, R (red), G (green), B (blue), B (blue), R (red), G (green), G (green), B (blue), . . . etc. Alternatively, each of the LEDs 12 may be a white LED.

Somewhat narrow-angle components of the incident light to the optical element portion 11 are collimated in a rim portion 11b of the outer hull having total reflection, and narrow-angle paraxial components of the light are collimated in a convex lens portion 11a. And the bar-like optical element portion 11 has almost the same sectional shape in the axial direction of the bar. The light guide portion 14 is a part which guides the light from the LED-array light source to the optical element portion 11.

As shown in FIG. 4, on the side of the light guide portion 14 where the substrate 13 is in contact, a concavity 14a is provided in a position where each of the LEDs 12 is arranged. That is, as shown in FIG. 2, a plurality of concavities 14a are formed in the light guide portion 14 so that when the substrate 13 is mounted to the light guide portion 14, each of the LEDs 12 on the substrate 13 is arranged within a corresponding concavity 14a.

Furthermore, the concavo-convex reflecting portions 14b are provided on a surface 14s of the light guide portion 14 on the side where the plurality of concavities 14a are formed.

Concretely, as shown in FIGS. 2 to 6, the concavo-convex reflecting portions 14b are concavo-convex portions formed in strip shape between two concavities 14a adjacent to each other. In the present embodiment, the concavo-convex reflecting portions 14b are formed from a plurality of prisms lining up in strip shape along a line connecting two concavities 14a adjacent to each other. Each of the prisms, which are the concavo-convex portions, has two flat portions having angles different from each other with the surface 14s on which the concavo-convex reflecting portions 14b are provided. And each surface of the two flat portions of each prism is parallel to a line orthogonal to a line connecting the two concavities 14a which are parallel to the surface 14s and adjacent to each other. And as shown in FIGS. 4 and 5, the concavities 14a and the concavo-convex reflecting portions 14b are alternately formed on the surface 14a parallel to the axis of the bar-like light guide portion 14.

The width of the strip-like concavo-convex reflecting portions 14b is equal to the width of each of the LEDs 12 (i.e., the length of the light emitting portion of the LED 12 in the longitudinal direction of FIG. 5 obtained when the LED 12 is arranged in the concavity 14a).

As shown in FIGS. 4 and 5, the planar part of the surface 14s of the light guide portion 14 has the outside shape of a contour formed when a plurality of ellipses line up on a straight line so as to partly overlap each other when the surface 14s is plane-viewed.

Incidentally, although in the present embodiment the shape of the surface 14s is an example of contour of a plurality of ellipses, the surface 14s may have the outside shape of a contour formed when a plurality of rhombuses or polygons (for example, pentagons and hexagons) line up on a straight line so as to partly overlap each other.

On the other hand, as shown in FIG. 6, a surface 14t on the optical element portion 11 side in the light guide portion 14, i.e., a section along the VI-VI line of FIG. 3 has the outside shape of a contour formed when a plurality of ellipses line up on a straight line so as to partly overlap each other, which are smaller than the ellipse of the surface 14s, when the surface 14t is plane-viewed. As shown in FIG. 6, the outside shape of the planar part of the surface 14t is smaller than the outside shape of the planar part of the surface 14s.

And the light guide portion 14 has two face portions having two surfaces 14u along the two outside shapes of the surface 14s and the surface 14t. The two face portions having the two surfaces 14u each form the totally reflecting portion.

As shown in FIG. 5, in a part corresponding to each ellipse in the outside shape of the surface 14s, the width in a direction orthogonal to a straight line L1, on which the plurality of concavities 14a line up, obtained when the surface 14s is plane-viewed, is largest in a part passing through the middle part of a line connecting two concavities 14a adjacent to each other. The width of the part having the largest width is indicated by width W1 in FIG. 5.

In the part corresponding to each ellipse, the width in a direction orthogonal to the straight line L1, on which the plurality of concavities 14a line up, obtained when the surface 14s is plane-viewed, is smallest in a part passing through the center of each of the concavities 14a. The width of the part having the smallest width is indicated by width W2 in FIG. 5.

Between the widths W1 and W2, in a part corresponding to each ellipse, the width in a direction orthogonal to the straight line L1, on which the pluralities of concavities 14a line up, decreases gradually from the width W1 to the width W2 along the shape of the ellipses.

In a part corresponding to each ellipse in the outside shape of the surface 14t, which is a section, the width in a direction orthogonal to the straight line L1 obtained when the surface 14t is plane-viewed, is largest in a part passing through the middle part of a line connecting projected two concavities 14a obtained when two concavities 14a adjacent to each other are projected on the surface 14t. The width of the part having the largest width is indicated by width W3 in FIG. 6.

In the part corresponding to each ellipse, the width in a direction orthogonal to a line connecting the projected two concavities 14a, obtained when the surface 14t is plane-viewed, is smallest in a part passing through the center of the projected two concavities 14a. The width of the part having the smallest width is indicated by width W4 in FIG. 6.

Between the widths W3 and W4, in a part corresponding to each ellipse, the width in a direction orthogonal to a line on which the projected two concavities 14a line up, decreases gradually from the width W3 to the width W4 along the shape of the ellipses.

Therefore, in a section which is orthogonal to an optical axis plane including the optical axis L and parallel to a direction in which the plurality of concavo-convex reflecting portions 14b line up, the distance between the two face portions having the two surfaces 14u is narrowest in a position where each of the LEDs 12 is arranged.

Incidentally, as described above, when the shapes of the surface 14s and the surface 14t are polygons, such as rhombuses, also the outside shape of the surface 14u becomes a polygon.

Therefore, in the sectional view of FIG. 3, the two surfaces 14u which connect the surface 14s of the light guide portion 14 and the surface 14t, which is a section, are surfaces inclined with a prescribed angle with respect to the optical axis L of each of the LEDs 12. Concretely, as shown in FIG. 3, each of the surfaces 14u of the two face portions is inclined so that the distance between the two surfaces 14u becomes short along the emitted light direction of the optical axis L.

The two surfaces 14u each have curved shapes along the outside shapes of the surfaces 14s and 14t. The two surfaces 14u have totally reflecting surfaces and totally reflect the light from each of the LEDs 12. The shapes of the totally reflecting surfaces of the two surfaces 14u have shapes of curved surface which are such that the reflected light from each of the LEDs 12 travels toward the plurality of concavo-convex reflecting portions 14b. Concretely, the shapes of the totally reflecting surfaces of the two surfaces 14u are shapes which cause the reflected light from each of the LEDs 12 to be guided toward the plurality of concavo-convex reflecting portions 14b arranged among the pluralities of LEDs 12 and onto the line on which the pluralities of concavo-convex reflecting portions 14b line up. And each of the concavo-convex reflecting portions 14b has a concavo-convex shape which reflects the incident light toward the incident portion of the optical element portion 11. That is, the light reflected on the pluralities of concavo-convex reflecting portions 14b is converted to light having directionality which permits spreading in the array direction of the light source 3.

The shape of the light guide portion 14 will be described here in relation to the emitted light from each of the LEDs 12.

Taking an LED 12 into consideration, the emitted light from the LED 12 is emitted in the direction of the optical axis L according to the luminous intensity distribution characteristics of the LED 12. Emitted light having an angle less than a prescribed angle with the optical axis plane of the LED 12 including the optical axis L (hereinafter referred to also as a narrow angle range), does not reach the two surfaces 14u of the totally reflecting portion. The light which does not reach the two surfaces 14u (for example, the light LT1 and the light LT2 in FIG. 3) either passes through the convex lens portion 11a in the middle of the optical element portion 11 and is emitted parallel to the optical axis plane, or is reflected in the rim portion 11b of the optical element portion 11 and emitted parallel to the optical axis plane.

In contrast to this, emitted light having an angle not less than the prescribed angle with the optical axis plane (hereinafter referred to also as a wide angle range) reaches the two surfaces 14u. The surfaces 14u have such a shape that when emitted light which reaches the two surfaces 14u is totally reflected on each of the surfaces 14u, the reflected light travels toward the concavo-convex reflecting portions 14b. Concretely, as shown in FIG. 3, the two face portions having the two surfaces 14u of the light guide portion 14 are formed in such a manner that as shown in FIG. 3, when viewed from the axial direction of the bar-like optical element for arrayed light source 3a, the reflected light from the two surfaces 14u travels toward the plurality of concavo-convex reflecting portions 14b.

FIGS. 3 and 4 show that the emitted light LT3 from each of the LEDs 12 is totally reflected on the surface 14u and travels toward the concavo-convex reflecting portions 14b and that the light which is further reflected on the concavo-convex reflecting portions 14b passes through the optical element portion 11 and is emitted substantially parallel to the optical axis L.

Incidentally, FIG. 4 shows only the optical path of the emitted light LT3 from the LED 12 positioned in the middle concavity 14a. However, also the emitted light from other plurality of LEDs 12 is similarly reflected on each of the concavo-convex reflecting portions 14b (when the concavo-convex reflecting portion 14b is present only on one side, the emitted light is reflected on this one concavo-convex reflecting portion 14b), and the reflected light passes through the optical element portion 11 and is emitted substantially parallel to the optical axis L.

That is, it can be said that the light guide portion 14 in the present embodiment is a wide-angle ray conversion portion which converts the guided light in a wide-angle range. In other words, the light guide portion 14 intentionally prevents direct output of ray components of the incident light from each of the LEDs 12 as a light emitting element in a wide-angle range in a direction orthogonal to the luminous surface of the diffuser 5, causes the ray components to be reflected on the surface 14u having a totally reflecting surface in the orthogonal direction (the vertical direction of FIG. 3), and temporarily returns the ray components to the positions where the strip-like concavo-convex reflecting portions 14b, which are provided on the line on which the plurality of LEDs 12 line up and extend along the line, are present. The light reflected on each of the concavo-convex reflecting portions 14b is collimated by the optical element portion 11.

As shown in FIGS. 5 and 6, just above and under each of the LEDs 12, the surfaces 14u having a totally reflecting surface have the shape of the letter V in a sectional shape parallel to the array direction. That is, the shape of the letter V is formed in such a manner that in a section which is orthogonal to the optical axis plane including the optical axis L and parallel to a direction in which the plurality of concavo-convex reflecting portions 14b line up, the distance between the two face portions having the two surfaces 14u in a position where each of the LEDs 12 is arranged, becomes narrowest. The light emitted just above and under each of the LEDs 12 therefrom is guided by being totally reflected in the array direction, i.e., the direction of the straight line L1 on which the plurality of concavities 14a line up. And as shown in FIGS. 3 and 4, the light is guided to the positions of the plurality of concavo-convex reflecting portions 14b which line up in the direction of the straight line L1.

The light emitted from each of the LEDs so as to be inclined in the direction of the straight line L1 has a large incident angle with the totally reflecting surface of the surface 14u. However, the surface 14u also totally reflects this light in the direction of the straight line L1 and guides the light in the array direction. After all, the light from each of the LEDs 12 reaches the concavo-convex reflecting portions 14b after being reflected once or several times, and is collimated to change the direction thereof in the optical axis direction. In other words, the light guide portion 14 has a reflection structure which causes the plurality of concavo-convex reflecting portions 14b formed in strip shape to guide the emitted light from the plurality of LEDs 12 in a wide-angle range to the incident portion of the optical element portion 11. That is, because the plurality of concavo-convex reflecting portions 14b are strip-like portions provided with concavities and convexities which are angled to collimate again the light guided by being totally reflected on the surface 14u and to change the direction of the light in the direction of the optical axis plane, it is possible to regard the concavo-convex reflecting portions 14b as a strip-like (linear) light source in a closely resembling manner.

If the plurality of LEDs 12 have the colors R, G, B, the light guided in the array direction has the colors mixed to some degree. That is, the light from the concavo-convex reflecting portions 14b is excellent in color mixing properties. In a white LED and a monochromatic LED which use a fluorescent substance, “fireflies,” i.e., hot spots in the vicinity of arrayed light sources are reduced, thereby greatly contributing in an improvement in the uniformity ratio of illuminance in the array direction.

As described above, the light guide portion 14 causes the emitted light from each of the LEDs having an angle not less than a prescribed angle to be totally reflected on the surface 14u of the totally reflecting portion, causes the reflected light to be further reflected in each of the plurality of concavo-convex reflecting portions 14b, and guides the light from the plurality of concavo-convex reflecting portions 14b and the emitted light from each of the LEDs 12 having an angle less than a prescribed angle to the incident portion of the optical element portion 11. Hence, almost all ray components in a wide angle range are reflected by the concavo-convex reflecting portions 14b and change the direction thereof to the optical axis direction. Therefore, these ray components do not become stray light and are effectively utilized, resulting in improved efficiency.

As described above, in the light emitting device 1 according to the present embodiment mentioned above, the optical element for arrayed light source 3a is used as an optical element for arrayed light source which has the light guide portion 14 constituting the above-described wide-angle ray conversion portion and a conventional collimator lens portion provided with the rim portion 11b of the outer hull.

Although the rim portion 11b of the outer hull is a portion for receiving and collimating light in a somewhat wide angle range, many of the wide-angle rays have already been converted to the optical axis direction by the light guide portion 14 as a wide-angle ray conversion portion. Hence, in such a case, rays of wider angles do not exist and, therefore, the totally reflecting rim portion 11b of the outer hull is unnecessary or it is possible to shorten the width in a direction orthogonal to the optical axis L of the totally reflecting rim portion 11b (or the distance from the optical axis L).

Hence, it is possible to reduce the thickness of the hollow-cavity type light emitting device of the present embodiment compared to the hollow-cavity type light emitting device of FIG. 15, because there is no large space factor.

Next, modifications will be described.

### First Modification:

In the above-described embodiment, it is ensured that each of the LEDs 12 is arranged in each of the concavities 14a of the light guide portion 14. In a first modification, however, a light guide portion 14 has a convex lens portion in order to raise the efficiency of light entrance into an optical element portion 11 from each of the LEDs 12.

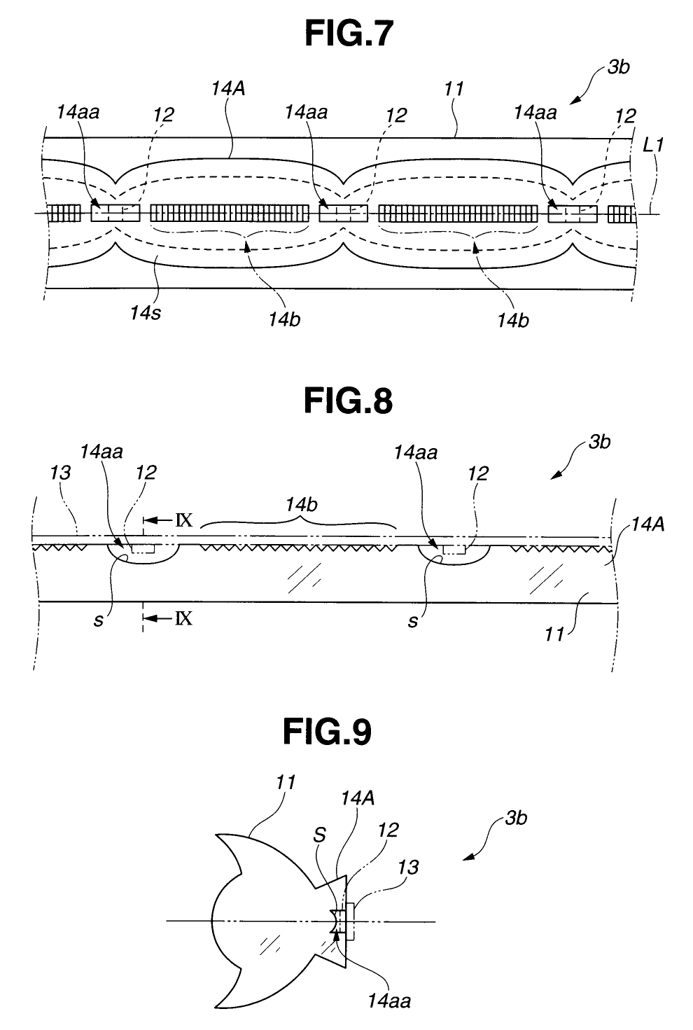

FIGS. 7 to 9 are diagrams to explain a light guide portion 14A in the present modification. FIG. 7 is a front view of a collimator lens 3b as viewed from the side where concavo-convex reflecting portions 14b of the light guide portion 14A are formed. FIG. 8 is a sectional view along the direction of the straight line L1 on which a plurality of concavo-convex reflecting portions 14b of the light guide portion 14A line up. FIG. 9 is a sectional view of the collimator lens along the IX-IX line in FIG. 8.

As shown in FIG. 7, in the light guide portion 14A, a concavity 14a a in which each of the LEDs 12 is arranged is not a mere concavity in which each of the LEDs 12 is capable of being arranged; as shown in FIG. 8, the sectional shape in the array direction, i.e., the straight line L1 direction has an inner surface S having a curvilinear concave shape, and the inner surface S is such that, as shown in FIG. 9, the sectional shape in a direction orthogonal to the straight line L1 has the shape of a convex lens. That is, each of the concavities 14a a has a convex lens portion having, as a surface receiving the light from each of the LEDs 12, an inner surface S which causes emitted light to be emitted widely in the straight line L1 direction and does not cause the emitted light to be emitted at wide angles in a direction orthogonal to the straight line L1.

According to this configuration, in the sectional view in the array direction, the inner surface S of the concavity 14a a is cut so as to have a curvilinear concavity, thereby improving the efficiency of light entrance of components in a lateral direction, i.e., in the array direction toward the optical element portion 11. Furthermore, because the inner surface S of the concavity 14a a is such that the sectional shape in a direction orthogonal to the straight line L1 has the shape of a convex lens, the efficiency of light entrance in the orthogonal direction is also high.

Incidentally, the plurality of LEDs 12 are arranged so as to line up linearly in the same array direction as with the plurality of concavo-convex reflecting portions 14b. That is, the plurality of LEDs 12 and the plurality of concavo-convex reflecting portions 14b are arranged so that an arrayed light source is formed. And the linear light source coincides also with the optical axis center of a convex lens portion 11a of the optical element portion 11.

Therefore, according to the present modification, it is possible to use a more compact collimator lens portion, and it is possible to realize a more efficient collimation effect.

### Second Modification:

Although in the above-described embodiment and the first modification, the light emitting device 1 is box-shaped and the luminous surface is rectangular, the light emitting device of a second modification is a light emitting device whose luminous surface is circular.

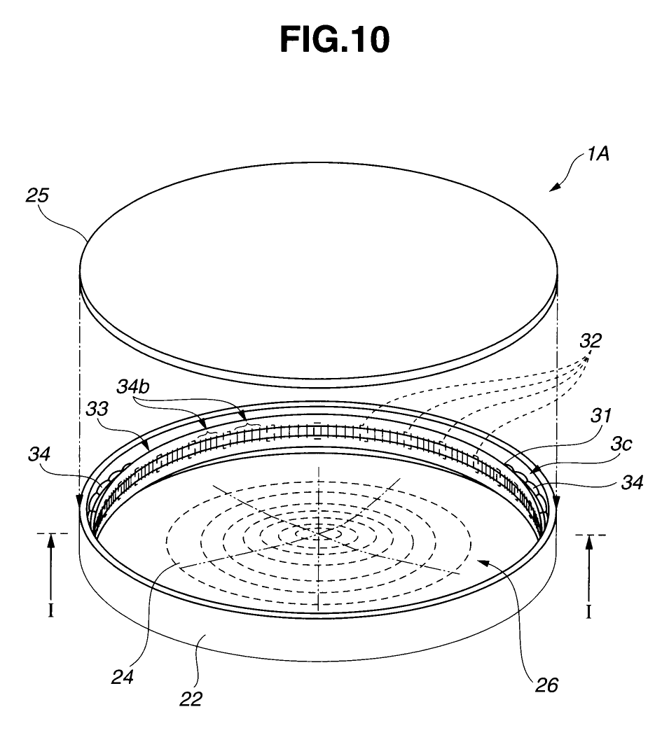

FIG. 10 is an assembly perspective view to explain the configuration of a light emitting device 1A in the present modification.

In the middle part of the bottom surface of a circular case 22 as plane-viewed is arranged a reflecting member 24 having a cone-shaped portion whose inclined surface in the sectional view has a curved line. That is, the reflecting member 24 has an inclined surface which is inclined gently from the middle part to the skirt part.

On the whole inner circumferential circumstance of an annular side face part of the case 22, a plurality of LEDs 32, which are light emitting elements provided on an unillustrated substrate, line up at predetermined intervals and the plurality of LEDs 32 are provided so as to emit emitted light toward the middle part of the reflecting member 24 as plane-viewed. In other words, the plurality of LEDs 32 are annularly provided in a direction in which optical axes O intersect each other at one point within the same plane, and each of the plurality of LEDs 32 emits light having narrow-angle luminous intensity distribution characteristics at the single point. A light source 33 including the plurality of LEDs 32 which line up annularly is used as side-illuminating light.

For this purpose, on the inner circumferential side of the plurality of LEDs 32, an annular collimator lens 3c is arranged so as to direct the emitted light from each of the LEDs 32 on the center of the case 22. The collimator lens 3c has an annular collimator lens portion 31 and an annular light guide portion 34 which is formed on the outer circumferential side of the collimator lens portion 31. As will be described later, the light guide portion 34 is an annular part which converts the luminous intensity distribution and the like of the emitted light from the light emitting element.

A disk-shaped diffuser 25 is provided on the top surface of the case 22 and a hollow cavity region 26 is provided between the reflecting member 24 and the diffuser 25.

Concretely, the diffuser 25 has a plane which provides a luminous surface parallel to the optical axis O of the emitted light from each of the LEDs 32. And the diffuser 25 is a circular member for diffusion reflection, which is arranged so as to be spaced a prescribed distance from the same plane and forms a luminous surface by diffusion reflection by receiving the emitted light from each of the LEDs 32.

The section of the light emitting device 1A along the I-I line of FIG. 10 is the same as in FIG. 1 described above. The case 22, the reflecting member 24, the diffuser 25, the hollow cavity region 26, the LED 32, the collimator lens 3c, the collimator lens portion 31 and the light guide portion 34 correspond to the case 2, the reflecting member 4, the diffuser 5, the hollow cavity region 6, the LED 12, the optical element for arrayed light source 3a, the optical element portion 11 and the light guide portion 14, respectively.

The light guide portion 34 has a plurality of concavo-convex reflecting portions 34b which are formed so as to be positioned between two arranged LEDs 32 which are adjacent to each other. Each of the concavo-convex reflecting portions 34b is formed from a prism in the same manner as the above-described concavo-convex reflecting portions 14b, for example. The light guide portion 34 guides the emitted light from each of the LEDs 32 in a circumferential direction. The light guide portion 34 has two surfaces (corresponding to the surfaces 14u of FIG. 3) formed so as to position an optical axis plane therebetween, and each surface is annular. And the shape of the totally reflecting surfaces of the two surfaces of the light guide portion 34 is such a shape that causes the light from each of the LEDs 32 to be reflected toward the plurality of concavo-convex reflecting portions 34b arranged between the plurality of LEDs 32 and guides the light onto a line in the circumferential direction of the light guide portion 34.

Therefore, also according to the light emitting device 1A of the present modification, it is possible to realize a hollow cavity type planar light emitting device whose thickness is small and which is capable of making uniform the illuminance distribution on a circular luminous surface. The light emitting device 1A of this modification can be applied not only to usual office or residential circular luminaries, but also to traffic lights, automotive speed meters and the like.

### Third Modification:

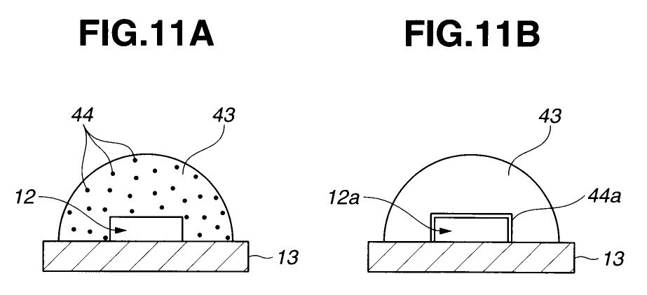

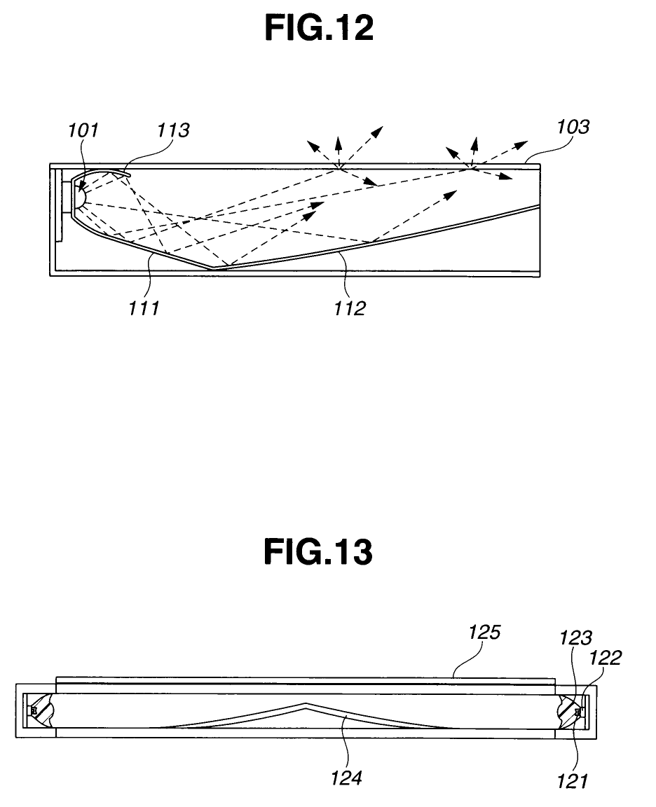

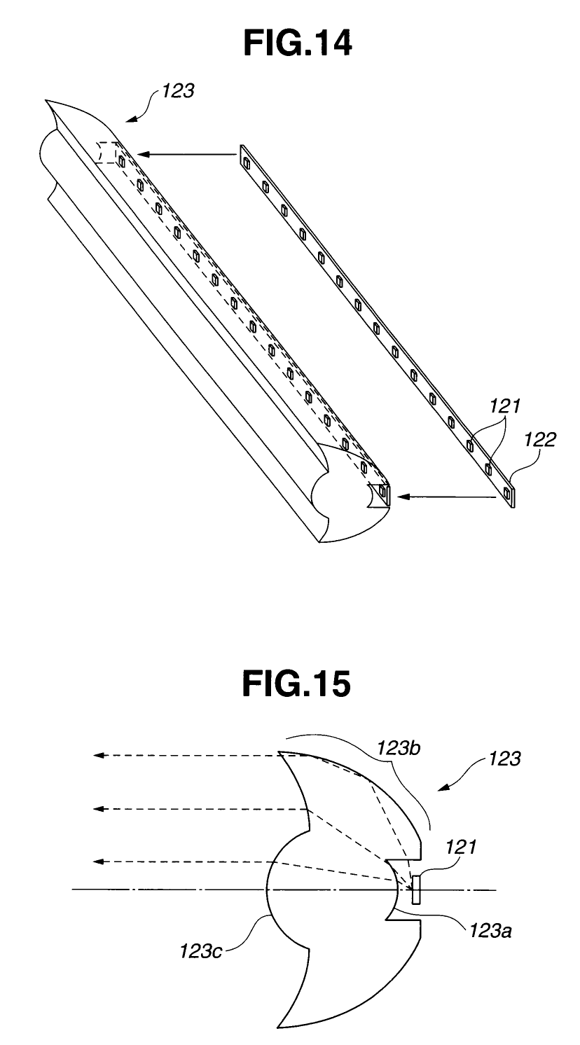

FIGS. 11A and 11B are diagrams to explain modifications of the light source.

In the above-described embodiment and each modification, the description was given of examples in which LEDs are used as the light source. However, there are also a case where white LEDs in which a florescent substance is used are used and a case where a fluorescent substance is distributed overall in a transparent resin of an LED package.

FIG. 11A is a sectional view showing the configuration of an LED in which a fluorescent substance is distributed overall in a resin. An LED chip 12 provided on a substrate 13 is covered with a transparent resin 43. A fluorescent substance 44 is included inside the whole transparent resin 43.

When the fluorescent substance 44 is distributed through the whole transparent resin 43 of an LED package as shown in FIG. 11A, the light emitted from the LED package cannot be regarded as a point source of light, with the result that in some cases it may be impossible to narrow the luminous intensity distribution even by using an optical system of a collimator lens and the like.

Particularly when the LED chip 12 is, for example, a InGaN-based blue LED chip and the fluorescent substance 44 is a yellow fluorescent substance (YAG or the like), quasi-white is realized by synthesizing the light emission of the two. In this case, in the light outputted through the optical system, color separation occurs due to the blue LED chip 12 close to a point source of light and the yellow fluorescent substance 44 distributed in the transparent resin 43 in a wide range. That is, due to a mismatch of the size of the luminescent region, a color irregularity of striped yellow and blue occurs with a large cycle on the plane of irradiation.

Therefore, in order to prevent such a color irregularity from occurring, it is preferred that the LED package of the light source be configured as shown in FIG. 11B.

In the LED package shown in FIG. 11B, an LED chip 12a is such that a fluorescent substance 44a is coated on a surface of the chip and a transparent resin 43 covers the LED chip 12a. On the surface of such an LED chip 12a, the fluorescent substance 44a is coated by the Conformal Phosphor Coating Process: (CP)².

That is, the LED chip 12a as a light emitting element in a light source 3 is such that the florescent substance 44a is provided on the surface thereof and the transparent resin 43 is provided on the fluorescent substance 44a so as to cover the LED chip 12a and the fluorescent substance 44a.

Because the use of such an LED package ensures that the color of the LED chip 12a itself and the color of the fluorescent substance 44a mix in the same place, the light emitted from the LED package does not cause color separation even if the light is caused to pass through an optical system. As a result of this, the LED package provides a white color source of a micro chip size. Therefore, a conversion to a narrow luminous intensity distribution becomes possible by use of a small collimator lens, it is possible to ensure that the light emitting devices of the above-described embodiment and each modification are free from color irregularity and have a small thickness.

Incidentally, although in the above-described LED package the fluorescent substance 44a is provided on the surface of the LED chip 12a, the fluorescent substance 44a may be provided in close proximity to the surface of the LED chip 12a instead of being provided on the surface of the LED chip 12a.

According to the above-described present embodiment and each modification thereof, the linear or annular light guide portion which converts the luminous intensity distribution and the like of the emitted light from the light emitting element guides wide-angle components of incoming light in the array direction or the circumferential direction and the strip-like optical structure provided between arrayed luminous points changes the direction of the emitted light from the LED 12 from the light guide direction to the optical axis direction of the optical element portion 11.

As a result of this, because it is possible to effectively utilize emitted light in a wide-angle range having angles not less than a prescribed angle, which have hitherto been stray light, the efficiency of light entrance from the light emitting element to the collimator lens is improved.

Because the light sources in the above-described present embodiment and each modification thereof look like a strip-like light source in a closely resembling manner rather than a light source in which a plurality of point sources of light are arranged in an arrayed manner, the color mixing properties are improved and also the uniformity is improved. Furthermore, because wide-angle components of incoming light are utilized by being guided in the vicinity of the incident portion instead of being collimated directly by total reflection in the rim portion of the outer hull, a large totally reflecting rim of the outer hull is unnecessary or can be scaled down. Therefore, it is possible to miniaturize the optical system itself of the light emitting device.

The light emitting devices of the above-described present embodiment and each modification thereof are devices which provide a uniform illuminance distribution on the luminous surface, and can be applied not only to, for example, a backlight device having high uniformity of illuminance on the luminous surface, but also to various kinds of devices such as usual luminaries.

For example, the hollow-cavity type linear or planar light emitting devices in the above-described present embodiment and each modification thereof can be applied to the backlight light source of a liquid crystal display (LCD), general illumination, various kinds of industrial illumination, light sources for imaging scan and the like. Particularly, because liquid crystal display devices, TV sets and luminaries in which the light emitting devices of the above-described present embodiment and each modification thereof are used can have light-weight and small-thickness designs and also can have an increased uniformity ratio of illuminance within the luminous surface, it is possible to substantially improve the performance.

Incidentally, although in the above-described present embodiment and each modification thereof LEDs are used as the light emitting elements of light source, laser diodes (LDs) and the like may also be used.

Furthermore, each modification may be applied in combination with one or more different modifications.

Hence, by using the principle described in the above-described present embodiment and each modification thereof, it is possible to realize a light emitting device of smaller-thickness design in which the luminous surface has a uniform luminance distribution.

The present invention is not limited to the above-described embodiment and each modification thereof, and various changes, modifications and the like can be made so long as these do not change the gist of the present invention.

What is claimed is:

1. An optical element for arrayed light source, comprising:
a bar-like or annular optical element portion; and
a light guide portion,
the light guide portion having a bar-like or annular shape provided on an incident portion side of the optical element portion, having a totally reflecting portion which causes emitted light from each of a plurality of light emitting elements that has an angle not less than a prescribed angle relative to an optical axis plane of the optical element portion to be totally reflected toward a plurality of concavo-convex reflecting portions provided between two light emitting elements adjacent to each other, the plurality of light emitting elements being arranged in a linear manner or an annular manner and each having directionality, and guiding, to the incident portion of the optical element portion, light reflected in each of the plurality of concavo-convex reflecting portions and emitted light from each of the plurality of light emitting elements that has an angle less than the prescribed angle.

2. The optical element for arrayed light source according to claim 1, wherein the totally reflecting portion of the light guide portion has two face portions formed so as to position the optical axis plane therebetween, and each of the face portions has a curved shape which causes light from the plurality of light emitting elements arranged in the linear manner or in the annular manner to be totally reflected toward each of the concavo-convex reflecting portions.

3. The optical element for arrayed light source according to claim 2, wherein in a section which is orthogonal to the optical axis plane and parallel to a direction in which the plurality of concavo-convex reflecting portions are provided, the distance between the two face portions in a position where each of the light emitting elements is arranged, is the narrowest.

4. The optical element for arrayed light source according to claim 1, wherein the optical element portion has a first convex lens portion which is formed on an emission portion side of the optical element portion and emits light which is guided by the light guide portion, parallel to the optical axis plane of the light emitting portion.

5. The optical element for arrayed light source according to claim 4, wherein the optical element portion further has two rim portions which are formed so as to position the optical axis plane of the optical element portion between the rim portions, causes light guided by the light guide portion to be reflected, and emits the light parallel to the optical axis plane of the optical element portion.

6. The optical element for arrayed light source according to claim 2, wherein the two face portions are formed to be inclined so that the distance between the two face portions becomes short along a direction of emitted light.

7. The optical element for arrayed light source according to claim 1, wherein the plurality of concavo-convex reflecting portions comprise a plurality of prisms formed on a surface of the light guide portion.

8. The optical element for arrayed light source according to claim 1, wherein the light guide portion has a second convex lens portion which is provided so as to correspond to each of the plurality of light emitting elements, collects light of less than the prescribed angle, and guides the light to the incident portion of the optical element portion.

9. A light emitting device having a luminous surface, comprising:
a light source,
the light source having a bar-like optical element portion, and a light guide portion having a bar-like shape provided on an incident portion side of the optical element portion, having a totally reflecting portion which causes emitted light from each of a plurality of light emitting elements that has an angle not less than a prescribed angle relative to an optical axis plane of the optical element portion to be totally reflected toward a plurality of concavo-convex reflecting portions provided between two light emitting elements adjacent to each other, the plurality of light emitting elements being arranged in a linear manner and each having directionality, and guiding, to the incident portion of the optical element portion, light reflected in each of the plurality of concavo-convex reflecting portions and emitted light from each of the plurality of light emitting elements that has an angle less than the prescribed angle;
a diffuser arranged so as to be spaced a prescribed distance from an optical axis plane of emitted light from the light source; and
a reflecting member which has an inclined surface having a prescribed inclination with respect to the optical axis plane so that illuminance distribution on the luminous surface becomes uniform, forms a hollow cavity region with the diffuser, and emits reflected light from the inclined surface to the diffuser via the hollow cavity region.

10. The light emitting device according to claim 9, wherein the totally reflecting portion of the light guide portion has two face portions formed so as to position the optical axis plane therebetween, and each of the face portions has a curved shape which causes light from the plurality of light emitting elements arranged in the linear manner to be totally reflected toward each of the concavo-convex reflecting portions.

11. The light emitting device according to claim 10, wherein in a section which is orthogonal to the optical axis plane and parallel to a direction in which the plurality of concavo-convex reflecting portions are provided, the distance between the two face portions in a position where each of the light emitting elements is arranged, is the narrowest.

12. The light emitting device according to claim 9, wherein the optical element portion has a convex lens portion which is formed on an emission portion side of the optical element portion and emits light which is guided by the light guide portion, parallel to the optical axis plane of the light emitting portion.

13. The light emitting device according to claim 9, wherein each of the plurality of light emitting elements includes an LED chip, a fluorescent substance provided on a surface of the LED chip, and a transparent resin covering the LED chip and the fluorescent substance.

14. A light emitting device having a luminous surface, comprising:
a light source,
the light source having an annular optical element portion, and a light guide portion having an annular shape provided on an incident portion side of the optical element portion, having a totally reflecting portion which causes emitted light from each of a plurality of light emitting elements that has an angle not less than a prescribed angle relative to an optical axis plane of the optical element portion to be totally reflected toward a plurality of concavo-convex reflecting portions provided between two light emitting elements adjacent to each other, the plurality of light emitting elements being arranged in an annular manner and each having directionality, and guiding, to the incident portion of the optical element portion, light reflected in each of the plurality of concavo-convex reflecting portions and emitted light from each of the plurality of light emitting elements that has an angle less than the prescribed angle;
a diffuser arranged so as to be spaced a prescribed distance from an optical axis plane of emitted light from the light source; and
a reflecting member which has an inclined surface having a prescribed inclination with respect to the optical axis plane so that illuminance distribution on the luminous surface becomes uniform, forms a hollow cavity region with the diffuser, and emits reflected light from the inclined surface to the diffuser via the hollow cavity region.

15. The light emitting device according to claim 14, wherein the totally reflecting portion of the light guide portion has two face portions formed so as to position the optical axis plane therebetween, and each of the face portions has a curved shape which causes light from the plurality of light emitting elements arranged in the annular manner to be totally reflected toward each of the concavo-convex reflecting portions.

16. The light emitting device according to claim 15, wherein in a section which is orthogonal to the optical axis plane and parallel to a direction in which the plurality of concavo-convex reflecting portions are provided, the distance between the two face portions in a position where each of the light emitting elements is arranged, is the narrowest.

17. The light emitting device according to claim 14, wherein the optical element portion has a convex lens portion which is formed on an emission portion side of the optical element portion and emits light which is guided by the light guide portion, parallel to the optical axis plane of the light emitting portion.

18. The light emitting device according to claim 14, wherein the plurality of light emitting elements are arranged so that optical axis thereof intersect each other at one point within the same plane.
